(19) United States
(12) Patent Application Publication
(10) Pub. No.: US 2022/0397879 A1
(43) Pub. Date: Dec. 15, 2022

(54) METHOD FOR EVALUATING RESONANCE STABILITY OF FLEXIBLE DIRECT CURRENT (DC) TRANSMISSION SYSTEM IN OFFSHORE WIND FARM

(71) Applicants: State Grid Jiangsu Electric Power Co., Ltd. Economic Research Institute, Nanjing, Jiangsu (CN); State Grid Jiangsu Electric Power Co., Ltd., Nanjing, Jiangsu (CN); State Grid Corporation of China, Beijing (CN)

(72) Inventors: Hui Cai, Nanjing, Jiangsu (CN); Wenjia Zhang, Nanjing, Jiangsu (CN); Zhuyi Peng, Nanjing, Jiangsu (CN); Sixuan Xu, Nanjing, Jiangsu (CN); Feifei Zhao, Nanjing, Jiangsu (CN); Facai Xing, Hangzhou, Zhejiang (CN); Chengchen Huang, Nanjing, Jiangsu (CN); Zhenjian Xie, Nanjing, Jiangsu (CN); Wanchun Qi, Nanjing, Jiangsu (CN); Wentao Sun, Nanjing, Jiangsu (CN); Zheng Xu, Hangzhou, Zhejiang (CN)

(21) Appl. No.: 17/603,977

(22) PCT Filed: Aug. 23, 2021
(86) PCT No.: PCT/CN2021/113950

§ 371 Date: Oct. 15, 2021

(30) Foreign Application Priority Data
Dec. 18, 2020 (CN) 202011503941.9

(51) Int. Cl. G05B 19/048; H02J 3/38; H02J 3/24

(52) U.S. Cl. CPC G05B 19/048; H02J 3/381; H02J 3/24; H02J 2300/28; G05B 2219/2619

(57) ABSTRACT

A method for evaluating resonance stability of a flexible direct current (DC) transmission system in an offshore wind farm includes: establishing an s-domain equivalent circuit of a flexible DC transmission system in an offshore wind farm, constructing an s-domain node admittance matrix of the flexible DC transmission system in the offshore wind farm, determining a resonant mode of the system based on a zero root of a determinant of the node admittance matrix, and determining stability of the system. In the method, an s-domain impedance model is used to describe dynamic characteristics of a wind turbine, a flexible DC converter, and other power devices, avoiding coupling between device modeling and an operation mode of the system. In addition, the node admittance matrix is used for analysis so as to fully consider a plurality of power electronic devices and a grid structure of the offshore wind farm, realizing comprehensive analysis.

### TECHNICAL FIELD

The present disclosure relates to the technical field of power transmission and distribution of a power system, and specifically, to a method for evaluating resonance stability of a flexible direct current (DC) transmission system in an offshore wind farm.

### BACKGROUND

To resolve the problems of shortage of fossil resources and ecological environment pollution, the government has successively issued a series of policies to encourage the development of clean and renewable energy. The development of the clean and renewable energy such as solar energy and wind energy has attracted extensive attention, and in particular, wind power dominated by wind power generation and photovoltaic power generation is developing rapidly. With the large-scale development of wind power, considering abundant offshore wind resources, a relatively stable wind speed, long-time use of generated power, avoidance of land occupation, and small impact on an ecological environment, the development of offshore wind power has gradually attracted attention of the government and enterprises, and is very fast. However, there is no generator synchronized in an offshore wind farm, and a system of the offshore wind farm lacks voltage frequency support, and has characteristics of a passive system. Moreover, affected by uncertainty of the wind energy, generated power of the wind farm fluctuates greatly, causing impact on an alternating current (AC) power grid.

Considering the characteristics of the passive system of the offshore wind farm and the power fluctuation of the offshore wind farm, a flexible DC transmission technology with a modular multilevel converter as the core is preferably used for a power transmission scheme of the offshore wind farm. On one hand, the flexible DC transmission technology with a modular multilevel converter as the core adopts a fully-controlled power electronic device, performs commutation without relying on the AC power grid, and can provide voltage frequency support for the offshore wind farm. On the other hand, the offshore wind farm is connected to the AC power grid by the flexible DC transmission technology, and therefore is decoupled from the AC power grid, which can reduce the impact of wind power fluctuation on the power grid to a certain extent.

However, when the offshore wind farm performs flexible DC transmission, the system of the offshore wind farm is mainly composed of a wind turbine, a flexible DC converter, and other power devices. The power devices have high response speeds and wide control frequency bands, and cause a negative resistance effect in a certain frequency band, resulting in a certain risk of resonance instability in the system. For example, in 2011, a plurality of oscillations in a subsynchronous frequency range (10 Hz to 50 Hz) occurred in a doubly-fed wind farm base in Guyuan of Hebei Province in China; in 2015, a plurality of oscillations in a supersynchronous frequency range (50 Hz to 100 Hz) occurred in a direct-drive wind farm base in Hami of Xinjiang in China; and in 2016, an oscillation with a frequency of about 1270 Hz occurred in a back-to-back flexible DC converter station in Luxi of Guangxi Province in China.

At present, most experts and scholars use a state space method or an impedance analysis method to evaluate resonance stability of the flexible DC transmission system in the offshore wind farm. The state space method can well reflect an unstable resonance mode of the system and determine a key influencing factor. However, in the state space method, detailed parameters of the wind power devices and the flexible DC converter are needed for modeling, and device modeling needs to be unified with an operation mode of the system. As a result, it is difficult to perform analysis, and workload is large, making it difficult to apply the state space method to a large-scale system. The impedance analysis method may not depend on the parameters of the wind power devices and the flexible DC converter, and can easily obtain impedance characteristics of ports of the wind power devices and the flexible DC converter through measurement. Moreover, an impedance model does not change with a change of a system structure, and can be independent of system-level analysis. Therefore, the impedance analysis method has certain advantages. However, the impedance analysis method is mainly used to determine stability of a port. For the flexible DC transmission system with many power electronic devices in the offshore wind farm, the offshore wind farm of the flexible DC transmission system is mostly equivalent to one or several power electronic devices, without considering a grid structure of the offshore wind farm and possible resonance modes inside the offshore wind farm, causing incomplete analysis.

### SUMMARY

In view of the above description, the present disclosure provides a method for evaluating resonance stability of a flexible DC transmission system in an offshore wind farm. The method includes: establishing an s-domain equivalent circuit of a flexible DC transmission system in an offshore wind farm, constructing an s-domain node admittance matrix of the flexible DC transmission system in the offshore wind farm, determining a resonant mode of the system based on a zero root of a determinant of the node admittance matrix, and determining stability of the system. In the method, an s-domain impedance model is used to describe dynamic characteristics of a wind turbine, a flexible DC converter, and other power devices, avoiding coupling between device modeling and an operation mode of the system. In addition, in the method, the node admittance matrix is used for analysis so as to fully consider a plurality of power electronic devices and a grid structure of the offshore wind farm, realizing comprehensive analysis.

A method for evaluating resonance stability of a flexible DC transmission system in an offshore wind farm is provided, where the transmission system includes the offshore wind farm and a flexible DC converter, the offshore wind farm converts wind energy into a DC and transmits the DC to the flexible DC converter, the converter further converts the DC into an alternating current (AC) to supply power to an onshore power grid system, and the method includes the following steps:

(1) establishing s-domain impedance models of power devices including a wind turbine, a step-up transformer, and a medium-voltage collecting submarine cable in the offshore wind farm;

(2) establishing an s-domain impedance model of the flexible DC converter;

(3) constructing an s-domain impedance equivalent circuit of the system based on the above established s-domain impedance models;

(4) establishing an s-domain node admittance matrix Y(s) of the system based on the s-domain impedance equivalent circuit;

(5) calculating a zero root s₀ of a determinant of the s-domain node admittance matrix Y(s) of the system in a frequency range of 1 Hz to 1000 Hz, in other words, solving an equation |Y(s₀)|=0; and

(6) using above calculated zero roots s₀ of all determinants as all resonant modes of the system in the frequency range of 1 Hz to 1000 Hz, describing the resonant modes in a complex form and presenting them in a complex plane coordinate system; and if the zero roots s₀ of all the determinants are located on a left-half plane of the complex plane coordinate system, determining that all the resonant modes are stable and the system has no risk of resonance instability; or if a zero root s₀ of any determinant is located on a right-half plane of the complex plane coordinate system, which indicates that a resonant mode corresponding to the determinant is unstable, determining that the system has a risk of resonant instability.

The establishing s-domain impedance models of a wind turbine, a step-up transformer, and a medium-voltage collecting submarine cable in step (1) specifically includes: analyzing transmission of a voltage perturbation component of a certain frequency of an AC system of the offshore wind farm in each power device and a quantitative correspondence between perturbation components based on a principle of frequency component balance, to determine a corresponding current perturbation component, and converting a frequency characteristic of port impedance of each power device into an s-domain impedance model of the power device based on a correspondence between a frequency domain and an s domain, where a ratio of the voltage perturbation component to the current perturbation component is port impedance of each power device at the frequency, and the power devices include the wind turbine, the step-up transformer, and the medium-voltage collecting submarine cable.

Further, there are two types of wind turbines in the offshore wind farm: a doubly-fed wind turbine and a direct-drive wind turbine.

Further, the doubly-fed wind turbine is composed of a fan, a rotor-side converter, and a grid-side converter, and its s-domain impedance model is as follows:

$${Z}_{DFIG} ( s ) = \frac{[ \frac{\{ \frac{s}{s - j {ω}_{m}} [ {R}_{r} + {Z}_{RSC} ( s - j {ω}_{m} ) ] + s ( {L}_{r} - M ) \} \times sM}{\{ \frac{s}{s - j {ω}_{m}} [ {R}_{r} + {Z}_{RSC} ( s - j {ω}_{m} ) ] + s ( {L}_{r} - M ) \} + sM} + {R}_{s} + s ( {L}_{s} - M ) ] \times [ {Z}_{GSC} ( s ) + {sL}_{g} ]}{[ \frac{\{ \frac{s}{s - j {ω}_{m}} [ {R}_{r} + {Z}_{RSC} ( s - j {ω}_{m} ) ] + s ( {L}_{r} - M ) \} \times sM}{\{ \frac{s}{s - j {ω}_{m}} [ {R}_{r} + {Z}_{RSC} ( s - j {ω}_{m} ) ] + s ( {L}_{r} - M ) \} + sM} + {R}_{s} + s ( {L}_{s} - M ) ] + [ {Z}_{GSC} ( s ) + {sL}_{g} ]}$$

$$\{ \begin{matrix}{Z}_{RSC} ( s ) = \frac{{R}_{RL , RSC} + {sL}_{RL , RSC} + {K}_{m , RSC} {U}_{dc , RSC} ( {H}_{In , RSC} ( s - j {ω}_{1} ) - {jK}_{i , RSC} ) {G}_{i , RSC}}{1 - {K}_{m , RSC} {U}_{dc , RSC} {K}_{v , RSC} {G}_{v , RSC}} \\ {Z}_{GSC} ( s ) = \frac{{R}_{RL , GSC} + {sL}_{RL , GSC} + {K}_{m , GSC} {U}_{dc , GSC} ( {H}_{In , GSC} ( s - j {ω}_{1} ) - {jK}_{i , GSC} ) {G}_{i , GSC}}{1 - {K}_{m , GSC} {U}_{dc , GSC} {K}_{v , GSC} {G}_{v , GSC}}\end{matrix}$$

where Z_{DFIG}(s) represents impedance of the doubly-fed wind turbine at a frequency s, ωₘ, represents an angular velocity of a rotor of the fan, Rᵣ represents resistance of the rotor of the fan, Lᵣ represents inductance of the rotor of the fan, Rₛ represents resistance of a stator of the fan, Lₛ represents inductance of the stator of the fan, M represents mutual inductance of the rotor and the stator of the fan, L_{g} represents filter inductance of the grid-side converter, Z_{RSC}(s) and Z_{RSC}(s−jωₘ) represent impedance of the rotor-side converter at frequencies s and s−jωₘ respectively,

Z_{GSC}(s) represents impedance of the grid-side converter at the frequency s, s represents a Laplace operator, j represents a imaginary unit, R_{RL,RSC} and L_{RL,RSC} represent resistance and inductance of an egress circuit of the rotor-side converter respectively, K_{m,RSC} represents a voltage modulation coefficient of the rotor-side converter, K_{m,GSC} represents a voltage modulation coefficient of the grid-side converter, U_{dc,RSC} represents a DC-side voltage of the rotor-side converter, U_{dc,GSC} represents a DC-side voltage of grid-side converter, H_{In,RSC}(s−jω₁) represents a transfer function for PI of inner-loop control of the rotor-side converter at a frequency s−jω₁, H_{In,GSC}(s−jω₁) represents a transfer function for PI of inner-loop control of the grid-side converter at the frequency s−jω₁, K_{i,RSC} represents a current decoupling coefficient of inner-loop control of the rotor-side converter, K_{i,GSC} represents a current decoupling coefficient of inner-loop control of the grid-side converter, G_{i,RSC} represents a per-unit coefficient of current measurement of the rotor-side converter, G_{i,GSC} represents a per-unit coefficient of current measurement of the grid-side converter, G_{v,RSC} represents a per-unit coefficient of voltage measurement of the rotor-side converter, G_{v,GSC} represents a per-unit coefficient of voltage measurement of the grid-side converter, K_{v,RSC} represents a voltage compensation coefficient of inner-loop control of the rotor-side converter, K_{v,GSC} represents a voltage compensation coefficient of inner-loop control of the grid-side converter, ω₁ represents an angular frequency of the power grid system, and R_{RL,GSC} and L_{RL,GSC} represent resistance and inductance of an egress circuit of the grid-side converter respectively.

Further, the direct-drive wind turbine is composed of a fan and a grid-tied converter, and its s-domain impedance model is as follows:

$$\begin{matrix}{Z}_{PMSG} ( s ) = {Z}_{VSC} ( s ) + {sL}_{g , VSC} \\ \{ {Z}_{VSC} ( s ) = \frac{{R}_{RL , VSC} + {sL}_{RL , VSC} + {K}_{m , VSC} {U}_{dc , VSC} ( {H}_{In , VSC} ( s - j {ω}_{1} ) - {jK}_{i , VSC} ) {G}_{i , VSC}}{1 - {K}_{m , VSC} {U}_{dc , VSC} {K}_{v , VSC} {G}_{v , VSC}}\end{matrix}$$

where, Z_{PMSG}(s) represents impedance of the direct-drive wind turbine at a frequency s, Z_{VSC}(s) represents impedance of the grid-tied converter at the frequency s, L_{g,VSC} represents filter inductance of the grid-tied converter, R_{RL,VSC} and L_{RL,VSC} represent resistance and inductance of an egress circuit of the grid-tied converter respectively, K_{m,VSC} represents a voltage modulation coefficient of the grid-tied converter, U_{dc,vsc} represents a DC-side voltage of the grid-tied converter, H_{In,VSC}(s−jω₁) represents a transfer function for PI of inner-loop control of the grid-tied converter at a frequency s−jω₁, K_{i,VSC} represents a current decoupling coefficient of inner-loop control of the grid-tied converter, G_{i,VSC} represents a per-unit coefficient of current measurement of the grid-tied converter, G_{v,VSC} represents a per-unit coefficient of voltage measurement of the grid-tied converter, K_{v,VSC} represents a voltage compensation coefficient of inner-loop control of the grid-tied converter, s represents a Laplace operator, j represents a imaginary unit, and ω₁ represents an angular frequency of the power grid system.

Further, a specific implementation of step (2) is as follows: building a simulation model of the flexible DC converter (in a V/F control mode) in electromagnetic transient-state simulation software; injecting a current perturbation component of a certain frequency into an AC side of the flexible DC converter to measure a corresponding voltage perturbation component, obtaining a ratio of the current perturbation component to the voltage perturbation component, namely, AC-side impedance of the flexible DC converter, and traversing each frequency to obtain a frequency characteristic curve of the AC-side impedance of the flexible DC converter; and finally obtaining the s-domain impedance model of the flexible DC converter by fitting points of the characteristic curve, where the s-domain impedance model is as follows:

$${Z}_{MMC} ( s ) = \frac{{a}_{n} {s}^{n} + {a}_{n - 1} {s}^{n - 1} + … + {a}_{1} s + {a}_{0}}{{b}_{m} {s}^{m} + {b}_{m - 1} {s}^{m - 1} + … + {b}_{1} s + {b}_{0}}$$

where Z_{MMC}(s) represents impedance of the flexible DC converter at a frequency s, a₀ to aₙ represent coefficients of a to-be-fitted numerator polynomial, b₀ to bₘ represent coefficients of a to-be-fitted denominator polynomial, s represents a Laplace operator, and n and m represent specified orders of the numerator polynomial and the denominator polynomial respectively.

Further, in step (5), the zero roots s₀ of all the determinants are obtained by solving the equation |Y(s₀)|=0 by a Jacobi iterative method or a Newton iterative method.

For an application scenario of evaluating a resonance risk of the flexible DC transmission system in the offshore wind farm, the method for evaluating resonance stability of a flexible DC transmission system in an offshore wind farm in the present disclosure uses the s-domain impedance model to describe dynamic characteristics of the wind turbine, the flexible DC converter, and other power devices, avoiding coupling between device modeling and an operation mode of the system. In addition, in the present disclosure, the node admittance matrix is used for analysis so as to fully consider a plurality of power electronic devices and a grid structure of the offshore wind farm, thereby providing some reference and guidance for planning and construction of an actual transmission project based on flexible DC transmission in the offshore wind farm.

### BRIEF DESCRIPTION OF THE DRAWINGS

FIG. 1 is a schematic flowchart of steps of a method for analyzing resonance stability of a flexible DC transmission system in an offshore wind farm according to the present disclosure;

FIG. 2 is a schematic structural diagram of a flexible DC transmission system in an offshore wind farm;

FIG. 3 is an equivalent schematic diagram of an s-domain impedance model of a doubly-fed wind turbine;

FIG. 4 is an equivalent schematic diagram of an s-domain impedance model of a direct-drive wind turbine;

FIG. 5(a) is a schematic diagram of a frequency characteristic of AC-side impedance (including an amplitude and a phase angle) of a flexible DC converter in a V/F control mode in a frequency range of 1 Hz to 100 Hz;

FIG. 5(b) is a schematic diagram of a frequency characteristic of AC-side impedance (including an amplitude and a phase angle) of a flexible DC converter in a V/F control mode in a frequency range of 100 Hz to 1000 Hz;

FIG. 6 is a schematic diagram of an example s-domain equivalent circuit of a flexible DC transmission system in an offshore wind farm; and

FIG. 7 is a schematic diagram of an example resonant mode of a flexible DC transmission system in an offshore wind farm.

### DETAILED DESCRIPTION

In order to more specifically describe the present disclosure, the technical solution of the present disclosure is described in detail below with reference to the accompanying drawings and specific implementations.

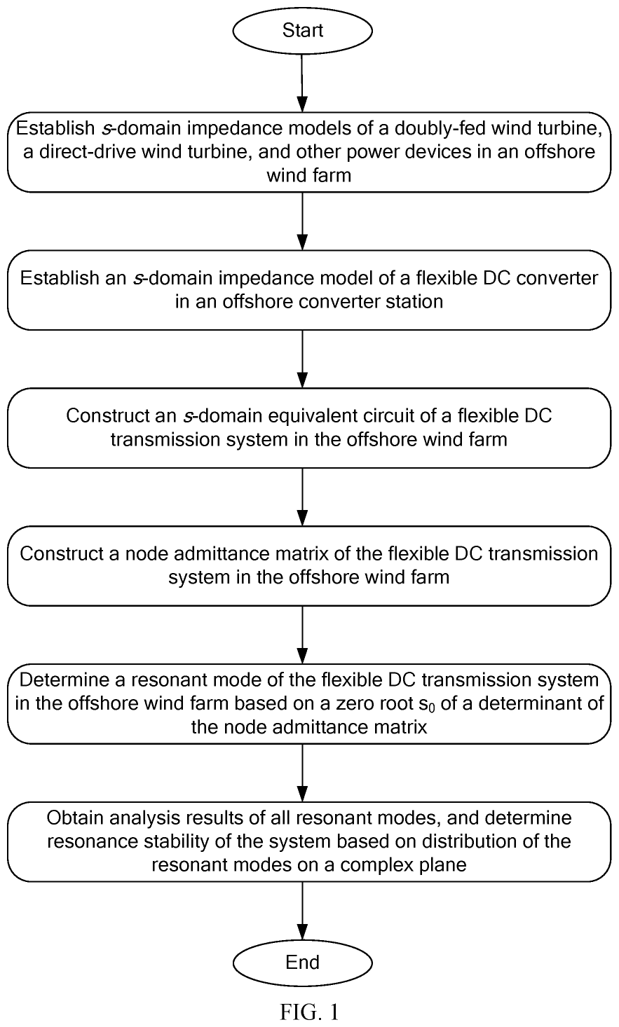

As shown in FIG. 1, a method for evaluating resonance stability of a flexible DC transmission system in an offshore wind farm in the present disclosure specifically includes the following steps:

(1) Establish s-domain impedance models of a wind turbine, a step-up transformer, a medium-voltage collecting submarine cable, and other power devices in an offshore wind farm, where this step specifically includes: analyzing transmission of a voltage perturbation component of a certain frequency of an AC system of the offshore wind farm in each power device and a quantitative correspondence between perturbation components based on a principle of frequency component balance, to determine a corresponding current perturbation component, and converting a frequency characteristic of port impedance of each power device into an s-domain impedance model of the power device based on a correspondence between a frequency domain and an s domain, where a ratio of the voltage perturbation component to the current perturbation component is port impedance of each power device at the frequency.

There are two types of wind turbines: a doubly-fed wind turbine and a direct-drive wind turbine. An s-domain impedance model of the doubly-fed power turbine is expressed as follows:

$${Z}_{DFIG} ( s ) = \frac{[ \frac{\{ \frac{s}{s - j {ω}_{m}} [ {R}_{r} + {Z}_{RSC} ( s - j {ω}_{m} ) ] + s ( {L}_{r} - M ) \} \times sM}{\{ \frac{s}{s - j {ω}_{m}} [ {R}_{r} + {Z}_{RSC} ( s - j {ω}_{m} ) ] + s ( {L}_{r} - M ) \} + sM} + {R}_{s} + s ( {L}_{s} - M ) ] \times [ {Z}_{GSC} ( s ) + {sL}_{g} ]}{[ \frac{\{ \frac{s}{s - j {ω}_{m}} [ {R}_{r} + {Z}_{RSC} ( s - j {ω}_{m} ) ] + s ( {L}_{r} - M ) \} \times sM}{\{ \frac{s}{s - j {ω}_{m}} [ {R}_{r} + {Z}_{RSC} ( s - j {ω}_{m} ) ] + s ( {L}_{r} - M ) \} + sM} + {R}_{s} + s ( {L}_{s} - M ) ] + [ {Z}_{GSC} ( s ) + {sL}_{g} ]}$$

$$\{ \begin{matrix}{Z}_{RSC} ( s ) = \frac{{R}_{RL , RSC} + {sL}_{RL , RSC} + {K}_{m} {U}_{dc} ( {H}_{In , RSC} ( s - j {ω}_{1} ) - {jK}_{i , RSC} ) {G}_{i}}{1 - {K}_{m} {U}_{dc} {K}_{v} {G}_{v}} \\ {Z}_{GSC} ( s ) = \frac{{R}_{RL , GSC} + {sL}_{RL , GSC} + {K}_{m} {U}_{dc} ( {H}_{In , GSC} ( s - j {ω}_{1} ) - {jK}_{i , GSC} ) {G}_{i}}{1 - {K}_{m} {U}_{dc} {K}_{v} {G}_{v}}\end{matrix}$$

where Z_{DFIG}(s) represents s-domain impedance of a doubly-fed fan system, Z_{RSC}(s) represents s-domain impedance of a rotor-side converter in the doubly-fed fan system, Z_{GSC}(s) represents s-domain impedance of a grid-side converter in the doubly-fed fan system, ωₘ represents a speed of a rotor of a fan, Rᵣ represents resistance of the rotor of the fan, Lᵣ represents inductance of the rotor of the fan, Rₛ represents resistance of a stator of the fan, Lₛ represents inductance of the stator of the fan, M represents mutual inductance of the rotor and the stator of the fan, L_{g} represents filter inductance of the converter, R_{RL,RSC} and L_{RL,RSC} represent resistance and inductance of an egress circuit of the rotor-side converter in the doubly-fed fan system respectively, Kₘ represents a voltage modulation coefficient of the converter, U_{dc} represents a DC-side voltage of the converter, H_{In,RSC}(s) represents a transfer function for PI of an inner-loop control of the rotor-side converter in the doubly-fed fan system, K_{i,RSC} represents a current decoupling coefficient of the inner-loop control of the rotor-side converter in the doubly-fed fan system, Gᵢ represents a per-unit coefficient of current measurement of the converter, Gᵥ represents a per-unit coefficient of voltage measurement of the converter, Kᵥ represents a voltage compensation coefficient of the inner-loop control of the converter, R_{RL,GSC} and L_{RL,GSC} represent resistance and inductance of an egress circuit the grid-side converter in the doubly-fed fan system respectively, H_{In,GSC}(s) represents a transfer function for PI of an inner-loop control of the grid-side converter in the doubly-fed fan system, and K_{i,GSC} represents a current decoupling coefficient of the inner-loop control of the grid-side converter in the doubly-fed fan system.

An s-domain impedance model of the direct-drive wind turbine is expressed as follows:

$$\begin{matrix}{Z}_{PMSG} ( s ) = {Z}_{VSC} ( s ) + {sL}_{g} \\ \{ {Z}_{VSC} ( s ) = \frac{{R}_{RL , VSC} + {sL}_{RL , VSC} + {K}_{m} {U}_{dc} ( {H}_{In , VSC} ( s - j {ω}_{1} ) - {jK}_{i , VSC} ) {G}_{i}}{1 - {K}_{m} {U}_{dc} {K}_{v} {G}_{v}}\end{matrix}$$

where Z_{PMSG}(s) represents s-domain impedance of a direct-drive fan system, Z_{VSC}(s) represents s-domain impedance of a grid-tied converter in the direct-drive fan system, R_{RL,VSC} and L_{RL,VSC} represent resistance and inductance of an egress circuit of the grid-tied converter in the direct-drive fan system respectively, H_{In,VSC}(s) represents a transfer function for PI of an inner-loop control of the grid-tied converter in the direct-drive fan system, and K_{i,VSC} represents a current decoupling coefficient of the inner-loop control of the grid-tied converter in the direct-drive fan system.

(2) Establish an s-domain impedance model of a flexible DC converter in an offshore converter station, where this step specifically includes: building a simulation model of the flexible DC converter (in a V/F control mode) in the offshore converter station in electromagnetic transient-state simulation software, injecting a current perturbation component of a certain frequency into an AC side of the flexible DC converter to measure a corresponding voltage perturbation component, obtaining a ratio of the current perturbation component to the voltage perturbation component, namely, AC-side impedance of the flexible DC converter, fitting a frequency characteristic of the AC-side impedance of the flexible DC converter based on results obtained at different frequencies, and converting the frequency characteristic of the AC-side impedance of the flexible DC converter into the s-domain impedance model of the flexible DC converter based on a correspondence between a frequency domain and an s domain.

The s-domain impedance model of the flexible DC converter is expressed as follows:

$${Z}_{MMC} ( s ) = \frac{{a}_{n} {s}^{n} + … + {a}_{k} {s}^{k} + … + {a}_{0}}{{b}_{m} {s}^{m} + … + {b}_{k} {s}^{k} + … + {b}_{0}}$$

where Z_{MMC}(s) represents s-domain impedance of the flexible DC converter, a₀, . . . aₖ, . . . aₙ represent coefficients of numerator terms of a fractional polynomial, b₀, . . . bₖ , . . . bₘ represent coefficients of denominator terms of the fractional polynomial, and n and m represent orders of the numerator terms and the denominator terms of the fractional polynomial respectively.

(3) Construct an s-domain equivalent circuit of a flexible DC transmission system in the offshore wind farm based on steps (1) and (2).

(4) Construct an s-domain node admittance matrix Y(s) of the flexible DC transmission system in the offshore wind farm based on step (3), where

$$Y ( s ) = [ \begin{matrix}{y}_{11} & … & {y}_{1 j} & … & {y}_{1 n} \\ ⋮ & ⋱ & ⋮ & ⋱ & ⋮ \\ {y}_{j 1} & … & {y}_{jj} & … & {y}_{jn} \\ ⋮ & ⋱ & ⋮ & ⋱ & ⋮ \\ {y}_{n 1} & … & {y}_{nj} & … & {y}_{nn}\end{matrix} ] .$$

(5) Calculate a zero root s₀ of a determinant of the node admittance matrix Y(s) of the flexible DC transmission in the offshore wind farm in a frequency range of 1 Hz to 1000 Hz, in other words, solve an equation |Y(s₀)|=0, based on step (4).

(6) Use above calculated zero roots s₀ of all determinants in step (5) as all resonant modes of the flexible DC transmission system in the offshore wind farm in the frequency range of 1 Hz to 1000 Hz, and determine resonance stability of the system based on distribution of the resonant modes on a complex plane; and if all the resonant modes are located on a left-half part of the complex plane, determine that all the resonant modes are stable and the system has no risk of resonance instability; or if a resonant mode is located on a right-half part of the complex plane, which indicates that the resonant mode is unstable, determine that the system has a risk of resonant instability.

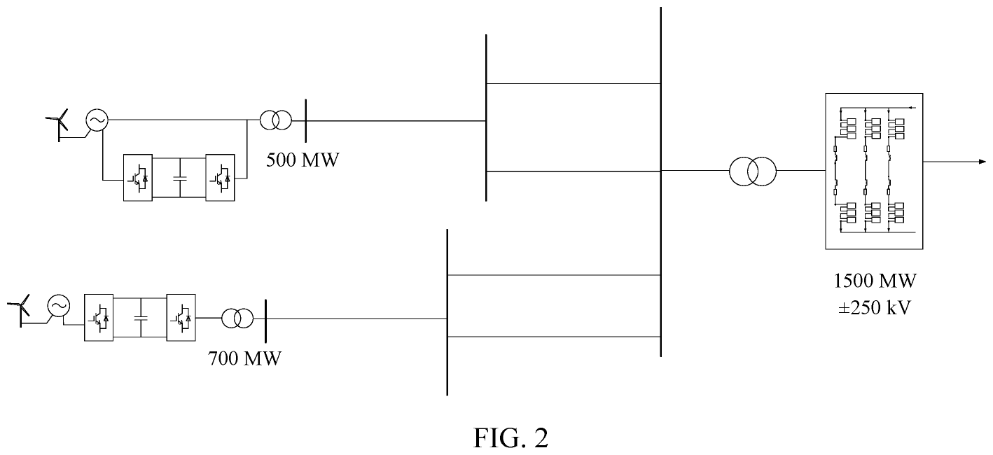

Next, a flexible DC transmission system in an offshore wind farm is used as an example, as shown in FIG. 2. Resonance stability of the flexible DC transmission system in the offshore wind farm is analyzed.

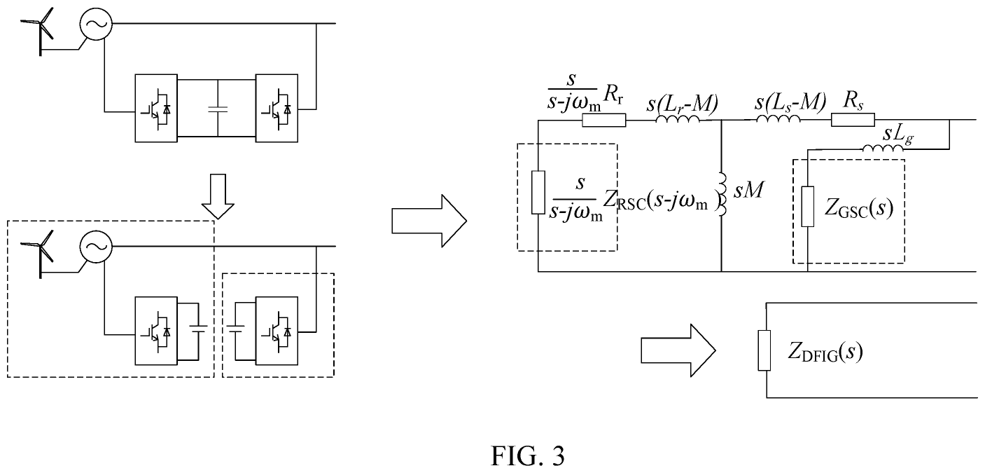

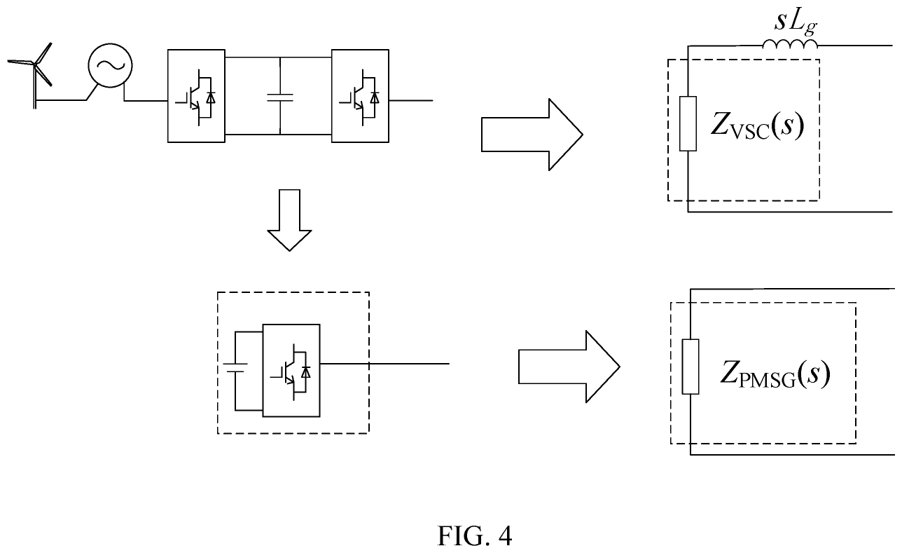

Step 1: Establish s-domain impedance models of a doubly-fed wind turbine and a direct-drive wind turbine in the offshore wind farm. A DC-side voltage of a converter generally remains constant. Therefore, the doubly-fed wind turbine and the direct-drive wind turbine each can be decomposed into grid-tied units dominated by a two-level voltage source converter. Based on a principle of frequency component balance, an s-domain impedance model of the two-level voltage source converter can be established. Then, based on the decomposition of the doubly-fed wind turbine and the direct-drive wind turbine, the s-domain impedance models of the doubly-fed wind turbine and the direct-drive wind turbine can be obtained, as shown in FIG. 3 and FIG. 4 respectively.

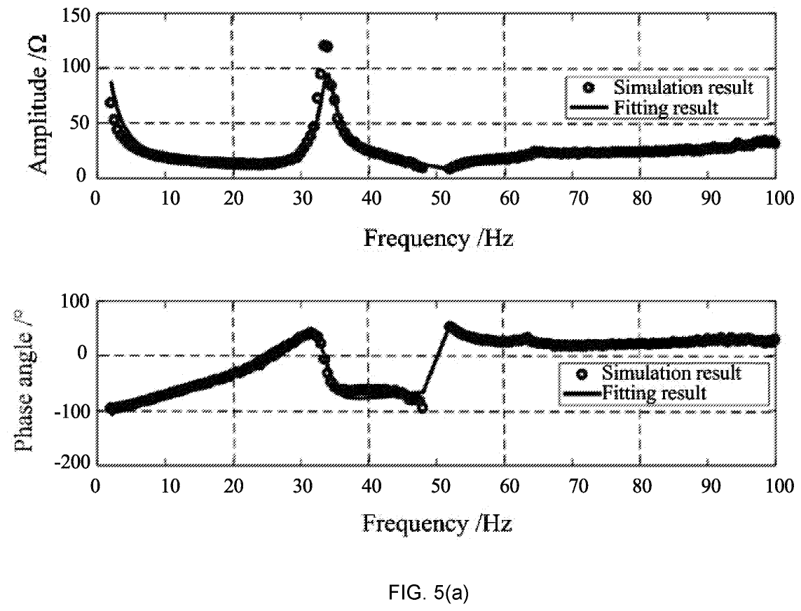

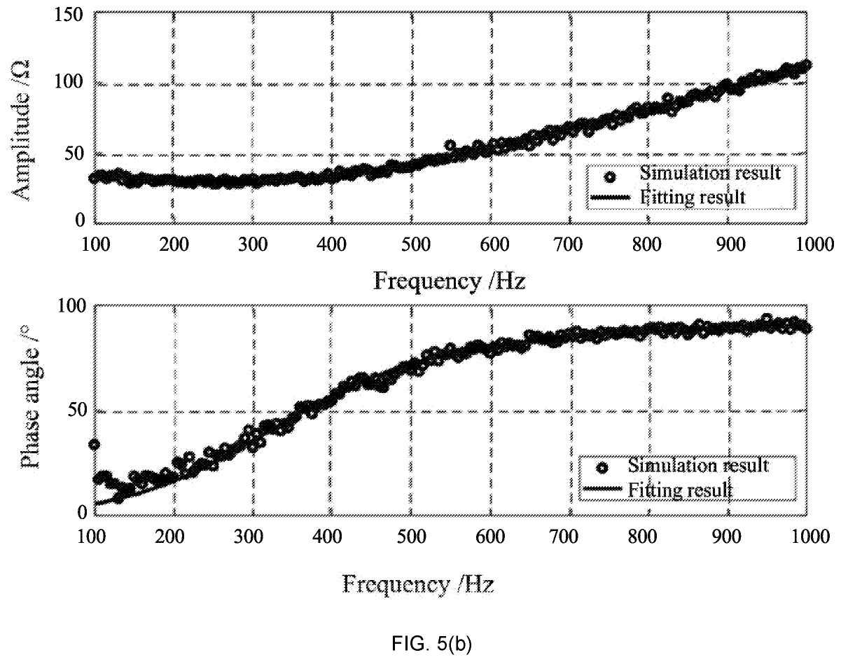

Step 2: Establish an s-domain impedance model of a flexible DC converter in an offshore converter station. A simulation model of the flexible DC converter (in a V/F control mode) in the offshore converter station is built in electromagnetic transient-state simulation software, a current perturbation component of a certain frequency is injected into an AC side of the flexible DC converter to measure a corresponding voltage perturbation component, a ratio of the current perturbation component to the voltage perturbation component, namely, AC-side impedance of the flexible DC converter, is obtained, a frequency characteristic of the AC-side impedance of the flexible DC converter can be fitted based on results obtained at different frequencies, and the frequency characteristic of the AC-side impedance of the flexible DC converter is converted into the s-domain impedance model of the flexible DC converter based on a correspondence between a frequency domain and an s domain. The frequency characteristic of the AC-side impedance of the flexible DC converter in the V/F control mode is shown in FIG. 5(a) and FIG. 5(b).

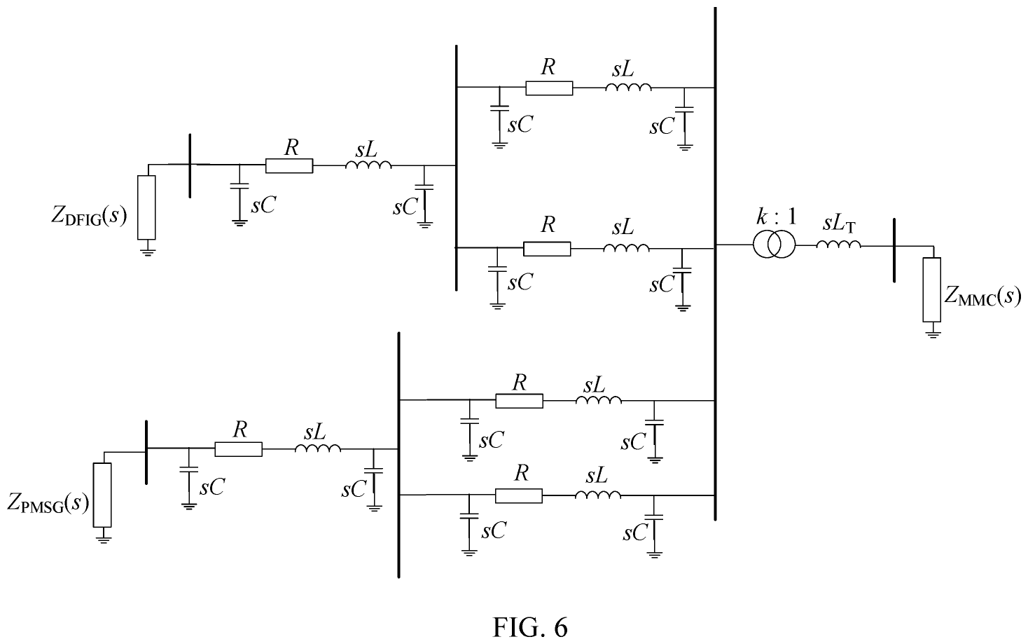

Step 3: Construct an examples-domain equivalent circuit of the flexible DC transmission system in the offshore wind farm. Based on the established s-domain impedance models of the doubly-fed wind turbine and the direct-drive wind turbine in the offshore wind farm, the s-domain impedance model of the flexible DC converter in the offshore converter station, and an example grid structure of the flexible DC transmission system in the offshore wind farm, the example s-domain equivalent circuit of the flexible DC transmission system in the offshore wind farm is constructed, as shown in FIG. 6.

Step 4: Establish an example s-domain node admittance matrix of the flexible DC transmission system in the offshore wind farm. Based on the constructed example s-domain equivalent circuit of the flexible DC transmission system in the offshore wind farm, all nodes can be numbered first, and then self admittance yᵢᵢ and mutual admittance yᵢⱼ of the nodes can be filled in according to a numbering sequence. After all the nodes in the system are traversed, the node admittance matrix Y(s) of the system is formed.

Step 5: Determine an example resonant mode of the flexible DC transmission system in the offshore wind farm and resonance stability of the flexible DC transmission system. The example resonant mode of the flexible DC transmission system in the offshore wind farm is determined, in other words, a zero root of a determinant of the node admittance matrix of the system is obtained. Firstly, a frequency characteristic of the determinant of the node admittance matrix of the system in a frequency range of 1 Hz to 1000 Hz is determined through frequency scanning, and an abnormal frequency point of the system is determined. Then, the abnormal frequency point is used as an initial value of a Newton-Raphson iterative method to obtain a solution iteratively. All resonant modes are obtained and presented in a complex plane coordinate system, and the resonance stability of the flexible DC transmission system in the offshore wind farm is determined based on distribution of the resonant modes. If all the resonant modes are located on a left-half complex plane, it is determined that all the resonant modes are stable and the system has no risk of resonance instability; or if a resonant mode is located on a right-half complex plane, it indicates that the resonant mode corresponding to the determinant is unstable, and it is determined that the system has a risk of resonant instability.

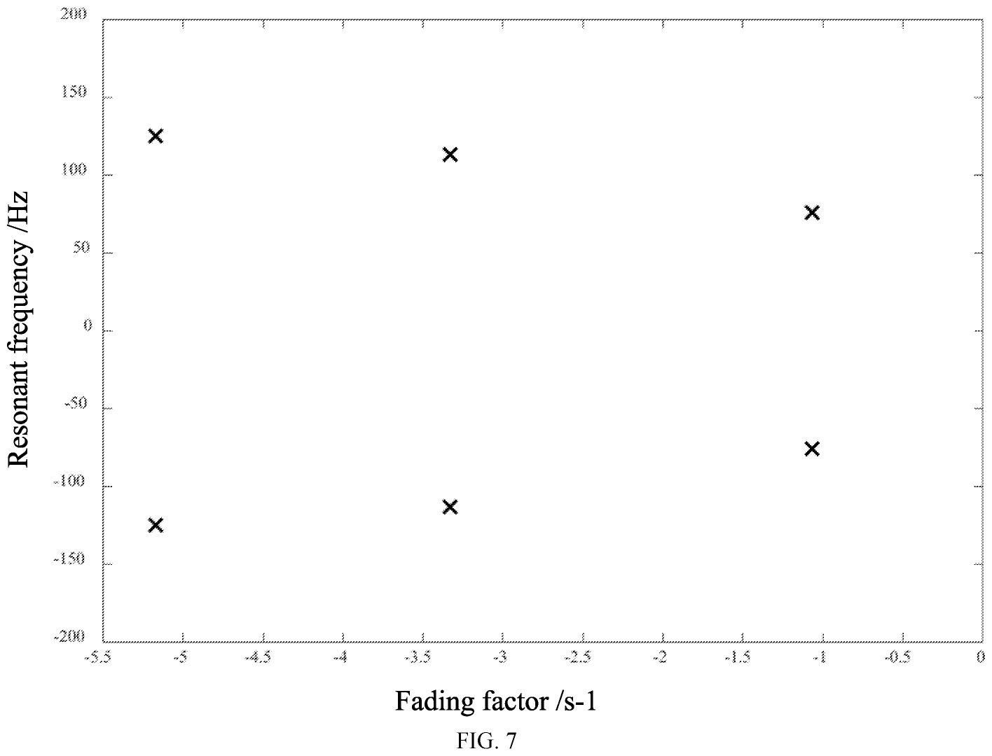

The example distribution of the resonant modes of the flexible DC transmission system in the offshore wind farm in this implementation is shown in FIG. 7. As shown in FIG. 7, the system mainly has three resonant modes with resonant frequencies being 76 Hz, 113 Hz, and 125 Hz respectively in the frequency range of 1 Hz to 1000 Hz, and the three resonant modes are all located on the left-half complex plane. Therefore, the three resonant modes are stable, and the system has no risk of resonant instability.

The above description of the embodiments is intended to facilitate a person of ordinary skill in the art to understand and use the present disclosure. Obviously, a person skilled in the art can easily make various modifications to these embodiments, and apply a general principle described herein to other embodiments without creative efforts. Therefore, the present disclosure is not limited to the embodiments herein. All improvements and modifications made by a person skilled in the art according to the disclosure of the present disclosure should fall within the protection scope of the present disclosure. CLAIMS:

1. A method for evaluating resonance stability of a flexible direct current (DC) transmission system in an offshore wind farm, wherein the transmission system comprises the offshore wind farm and a flexible DC converter, the offshore wind farm converts wind energy into a DC and transmits the DC to the flexible DC converter, the converter further converts the DC into an alternating current (AC) to supply power to an onshore power grid system, and the method comprises the following steps:
(1) establishing s-domain impedance models of power devices comprising a wind turbine, a step-up transformer, and a medium-voltage collecting submarine cable in the offshore wind farm;
(2) establishing an s-domain impedance model of the flexible DC converter;
(3) constructing an s-domain impedance equivalent circuit of the system based on the above established s-domain impedance models;
(4) establishing an s-domain node admittance matrix Y(s) of the system based on the s-domain impedance equivalent circuit;
(5) calculating a zero root s₀ of a determinant of the s-domain node admittance matrix Y(s) of the system in a frequency range of 1 Hz to 1000 Hz, in other words, solving an equation |Y(s₀)=0; and
(6) using above calculated zero roots s₀ of all determinants as all resonant modes of the system in the frequency range of 1 Hz to 1000 Hz, describing the resonant modes in a complex form and presenting them in a complex plane coordinate system; and if the zero roots so of all the determinants are located on a left-half plane of the complex plane coordinate system, determining that all the resonant modes are stable and the system has no risk of resonance instability; or if a zero root s₀ of any determinant is located on a right-half plane of the complex plane coordinate system, which indicates that a resonant mode corresponding to the determinant is unstable, determining that the system has a risk of resonant instability.

2. The method according to claim 1, wherein the establishing s-domain impedance models of a wind turbine, a step-up transformer, and a medium-voltage collecting submarine cable in step (1) specifically comprises:
analyzing transmission of a voltage perturbation component of a certain frequency of an AC system of the offshore wind farm in each power device and a quantitative correspondence between perturbation components based on a principle of frequency component balance, to determine a corresponding current perturbation component, and converting a frequency characteristic of port impedance of each power device into an s-domain impedance model of the power device based on a correspondence between a frequency domain and an s domain, wherein a ratio of the voltage perturbation component to the current perturbation component is port impedance of each power device at the frequency, and the power devices comprise the wind turbine, the step-up transformer, and the medium-voltage collecting submarine cable.

3. The method according to claim 1, wherein there are two types of wind turbines in the offshore wind farm: a doubly-fed wind turbine and a direct-drive wind turbine.

4. The method according to claim 3, wherein the doubly-fed wind turbine is composed of a fan, a rotor-side converter, and a grid-side converter, and its s-domain impedance model is as follows:
$${Z}_{DFIG} ( s ) = \frac{[ \frac{\{ \frac{s}{s - j {ω}_{m}} [ {R}_{r} + {Z}_{RSC} ( s - j {ω}_{m} ) ] + s ( {L}_{r} - M ) \} \times sM}{\{ \frac{s}{s - j {ω}_{m}} [ {R}_{r} + {Z}_{RSC} ( s - j {ω}_{m} ) ] + s ( {L}_{r} - M ) \} + sM} + {R}_{s} + s ( {L}_{s} - M ) ] \times [ {Z}_{GSC} ( s ) + {sL}_{g} ]}{[ \frac{\{ \frac{s}{s - j {ω}_{m}} [ {R}_{r} + {Z}_{RSC} ( s - j {ω}_{m} ) ] + s ( {L}_{r} - M ) \} \times sM}{\{ \frac{s}{s - j {ω}_{m}} [ {R}_{r} + {Z}_{RSC} ( s - j {ω}_{m} ) ] + s ( {L}_{r} - M ) \} + sM} + {R}_{s} + s ( {L}_{s} - M ) ] + [ {Z}_{GSC} ( s ) + {sL}_{g} ]}$$
$$\{ \begin{matrix}{Z}_{RSC} ( s ) = \frac{{R}_{RL , RSC} + {sL}_{RL , RSC} + {K}_{m , RSC} {U}_{dc , RSC} ( {H}_{In , RSC} ( s - j {ω}_{1} ) - {jK}_{i , RSC} ) {G}_{i , RSC}}{1 - {K}_{m , RSC} {U}_{dc , RSC} {K}_{v , RSC} {G}_{v , RSC}} \\ {Z}_{GSC} ( s ) = \frac{{R}_{RL , GSC} + {sL}_{RL , GSC} + {K}_{m , GSC} {U}_{dc , GSC} ( {H}_{In , GSC} ( s - j {ω}_{1} ) - {jK}_{i , GSC} ) {G}_{i , GSC}}{1 - {K}_{m , GSC} {U}_{dc , GSC} {K}_{v , GSC} {G}_{v , GSC}}\end{matrix}$$
wherein Z_{DFIG}(s) represents impedance of the doubly-fed wind turbine at a frequency s, ωₘ represents an angular velocity of a rotor of the fan, Rᵣ represents resistance of the rotor of the fan, Lᵣ represents inductance of the rotor of the fan, Rₛ represents resistance of a stator of the fan, Lₛ represents inductance of the stator of the fan, M represents mutual inductance of the rotor and the stator of the fan, L_{g} represents filter inductance of the grid-side converter, Z_{RSC}(s) and Z_{RSC}(s−jωₘ) represent impedance of the rotor-side converter at frequencies s and s−jωₘ respectively, Z_{GSC}(s) represents impedance of the grid-side converter at the frequency s, s represents a Laplace operator, j represents a imaginary unit, R_{RL,RSC} and L_{RL,RSC} represent resistance and inductance of an egress circuit of the rotor-side converter respectively, K_{m,RSC} represents a voltage modulation coefficient of the rotor-side converter, K_{m,GSC} represents a voltage modulation coefficient of the grid-side converter, U_{dc,RSC} represents a DC-side voltage of the rotor-side converter, U_{dc,GSC} represents a DC-side voltage of the grid-side converter, H_{In, RSC}(s−jω₁) represents a transfer function for PI of inner-loop control of the rotor-side converter at a frequency s−jω₁, H_{In,GSC}(s−jω₁) represents a transfer function for PI of inner-loop control of the grid-side converter at the frequency s−jω₁, K_{i,RSC} represents a current decoupling coefficient of inner-loop control of the rotor-side converter, K_{i,GSC} represents a current decoupling coefficient of inner-loop control of the grid-side converter, G_{i,RSC} represents a per-unit coefficient of current measurement of the rotor-side converter, G_{i,GSC} represents a per-unit coefficient of current measurement of the grid-side converter, G_{v,RSC} represents a per-unit coefficient of voltage measurement of the rotor-side converter, G_{v,GSC} represents a per-unit coefficient of voltage measurement of the grid-side converter, K_{v,RSC} represents a voltage compensation coefficient of inner-loop control of the rotor-side converter, K_{v,GSC} represents a voltage compensation coefficient of inner-loop control of the grid-side converter, ω₁ represents an angular frequency of the power grid system, and R_{RL,GSC} and L_{RL,GSC} represent resistance and inductance of an egress circuit of the grid-side converter respectively.

5. The method according to claim 3, wherein the direct-drive wind turbine is composed of a fan and a grid-tied converter, and its s-domain impedance model is as follows:
$$\begin{matrix}{Z}_{PMSG} ( s ) = {Z}_{VSC} ( s ) + {sL}_{g , VSC} \\ \{ {Z}_{VSC} ( s ) = \frac{{R}_{RL , VSC} + {sL}_{RL , VSC} + {K}_{m , VSC} {U}_{dc , VSC} ( {H}_{In , VSC} ( s - j {ω}_{1} ) - {jK}_{i , VSC} ) {G}_{i , VSC}}{1 - {K}_{m , VSC} {U}_{dc , VSC} {K}_{v , VSC} {G}_{v , VSC}}\end{matrix}$$
wherein, Z_{PMSG}(s) represents impedance of the direct-drive wind turbine at a frequency s, Z_{VSC}(s) represents impedance of the grid-tied converter at the frequency s, L_{g,VSC} represents filter inductance of the grid-tied converter, R_{RL,VSC} and L_{RL,VSC} represent resistance and inductance of an egress circuit of the grid-tied converter respectively, K_{m,VSC} represents a voltage modulation coefficient of the grid-tied converter, U_{dc,VSC} represents a DC-side voltage of the grid-tied converter, H_{In,VSC}(s−jω₁) represents a transfer function for PI of inner-loop control of the grid-tied converter at a frequency s−jω₁, K_{i,VSC} represents a current decoupling coefficient of inner-loop control of the grid-tied converter, G_{i,VSC} represents a per-unit coefficient of current measurement of the grid-tied converter, G_{v,VSC} represents a per-unit coefficient of voltage measurement of the grid-tied converter, K_{v,VSC} represents a voltage compensation coefficient of inner-loop control of the grid-tied converter, s represents a Laplace operator, j represents a imaginary unit, and ω₁ represents an angular frequency of the power grid system.

6. The method according to claim 1, wherein a specific implementation of step (2) is as follows: building a simulation model of the flexible DC converter in electromagnetic transient-state simulation software, injecting a current perturbation component of a certain frequency into an AC side of the flexible DC converter to measure a corresponding voltage perturbation component, obtaining a ratio of the current perturbation component to the voltage perturbation component, namely, AC-side impedance of the flexible DC converter, and traversing each frequency to obtain a frequency characteristic curve of the AC-side impedance of the flexible DC converter; and finally obtaining the s-domain impedance model of the flexible DC converter by fitting points of the characteristic curve, wherein the s-domain impedance model is as follows:
$${Z}_{MMC} ( s ) = \frac{{a}_{n} {s}^{n} + {a}_{n - 1} {s}^{n - 1} + … + {a}_{1} s + {a}_{0}}{{b}_{m} {s}^{m} + {b}_{m - 1} {s}^{m - 1} + … + {b}_{1} s + {b}_{0}}$$
wherein Z_{MMC}(s) represents impedance of the flexible DC converter at a frequency s, a₀ to aₙ represent coefficients of a to-be-fitted numerator polynomial, b₀ to bₘ represent coefficients of a to-be-fitted denominator polynomial, s represents a Laplace operator, and n and m represent specified orders of the numerator polynomial and the denominator polynomial respectively.

7. The method according to claim 1, wherein in step (5), the zero roots s₀ of all the determinants are obtained by solving the equation |Y(s₀)|=0 by a Jacobi iterative method or a Newton iterative method.
